(19) United States
(12) Patent Application Publication
(10) Pub. No.: US 2010/0085849 A1
(43) Pub. Date: Apr. 8, 2010

(54) OPTICAL DISC DRIVE AND METHOD FOR PREPROCESSING A DISC READ OUT SIGNAL

(75) Inventors: Bin Yin, Eindhoven (NL); Ruud Vlutters, Eindhoven (NL); Willem Marie Julia Marcel Coene, Eindhoven (NL); Theodorus Petrus Henricus Gerardus Jansen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/444,700

(22) PCT Filed: Oct. 4, 2007
(86) PCT No.: PCT/IB2007/054028

§ 371 Date: Apr. 8, 2009

(30) Foreign Application Priority Data
Oct. 10, 2006 (EP) 06122032.3

(51) Int. Cl. G11B 20/00

(52) U.S. Cl. 369/47.15; G9B/20

(57) ABSTRACT

The present invention discloses an optical drive and a method for preprocessing a disc readout signal rₖ of an optical drive on the basis of a set of low-pass filters. The cutoff frequency f_{C} of the filters wk, more particularly, can be set within the optical bandwidth, which improves the Viterbi detection performance in the case of high speed drive operations. Three types of filters are described, in which a Type I shaping filter performs best given a limited hardware cost for the bit detector. Compared to other more advanced noise-whitening techniques, it is only speed dependent and requires little prior knowledge of the channel and noise, thus cheap and easy to design. The invention can be applied in connection with optical disc drives, in particular when high frequency noises are dominant, for example, in the case of high speed operations.

### FIELD OF THE INVENTION

The invention is directed to an optical disc drive comprising preprocessor means for preprocessing a disc readout signal rₖ and detector means for making bit decisions on the basis of a preprocessed disc readout signal yₖ.

Furthermore, the invention is directed to a method for preprocessing a disc readout signal rₖ of an optical drive.

### BACKGROUND OF THE INVENTION

In optical disc drives, a detector makes bit decisions on the disc readout signal that has been properly preprocessed. The preprocessing includes, for example, low-pass and high-pass filtering for removing DC variation and high frequency (electronic) noise, automatic gain control, (adaptive) channel equalization and timing recovery. It targets at optimizing the signal-to-noise ratio (SNR) before bit detection. This is realized either in a fixed manner, like with low-pass and high-pass filtering, or in a dynamic manner, like with adaptive channel equalization. The readout process can be modelled in discrete-time domain as shown in FIG. 1, where aₖ, nₖ and rₖ represent a binary input, additive noise and readout signal, respectively. hₖ represents a symbol response of the optical channel, wₖ a filter for signal preprocessing and yₖ its output going to the detector.

The SNR gets optimized differently with detection types. In threshold detection, a ONE is detected with the data sample above the threshold and a ZERO is detected with the data sample below the threshold. Here the readout of a shortest effect (or run length) on a disc, which is, for example, two consecutive ONEs or ZEROs (so-called I2) in Blu-ray and three consecutive ONEs or ZEROs (so-called I3) in CD and DVD, is most critical because it has lowest amplitude due to the low-pass nature of the optical channel and thus is most vulnerable to noises. In this case, the SNR is improved simply by means of boosting I2 (or I3) amplitude with an equalizer while the total SNR over the whole frequency band gives less significance.

In sequence detection, on the other hand, like maximum likelihood sequence detection (MLSD) or Viterbi, the bit decisions are made sequence wise, meaning different data frequencies get equally important, so that the integral of SNR across all frequencies has to be considered in the optimization. In “J. W. M. Bergmans, Digital Baseband Transmission and Recording, Kluwer Academic Publishers, 1996” a so-called matched filter bound ρ_{MFB} is defined that is an upper bound of the pre-detection signal-to-noise ratio. For the optical readout as modelled in FIG. 1, normally characterized in a negative excess bandwidth, ρ_{MFB} can be defined as

$${ρ}_{MFB} = \frac{1}{T} {\int }_{0}^{1} \frac{{\vert H ( f ) \vert}^{2}}{N ( f )} d f , \qquad ( 1 )$$

where T represents the sampling period or its spatial equivalence, channel bit length T_{CBL}. H(f) and N(f) represent the Fourier transform of hₖ and power spectral density (PSD) of nₖ, respectively. When the noise is white, i.e. N(f)=N₀, the matched filter bound boils down to

$${ρ}_{MFB} = \frac{1}{{TN}_{0}} {\int }_{0}^{1} {\vert H ( f ) \vert}^{2} d f .$$

For the one-shot receiver, ρ_{MFB} is attainable when wₖ equals a matched filter with a Fourier transform

$$\frac{{H}^{*} ( f )}{N ( f )}$$

and no inter-symbol interference

(ISI) is present, i.e., transmitting a single bit. Here ‘*’ represents complex conjugation, the frequency domain analogue of time-reversal.

For MLSD or Viterbi detection, under the assumption that an exact channel response (until the detector), that is (h * w)ₖ (‘*’ represents linear convolution), is employed to generate required model outputs for the detection, a specific pre-detection signal-to-noise ratio ρ_{MLSD} can be defined [1], which has the form of

$$\begin{matrix}{ρ}_{MLSD} = {min}_{\underline{e} ∈ S} ρ ( \underline{e} ) & ( 2 ) \\ ρ ( \underline{e} ) = \frac{{[ {\int }_{0}^{1} {\vert E ( f ) \vert}^{2} {\vert H ( f ) W ( f ) \vert}^{2} d f ]}^{2}}{{\int }_{0}^{1} {\vert E ( f ) \vert}^{2} {\vert H ( f ) W ( f ) \vert}^{2} {\vert W ( f ) \vert}^{2} N ( f ) d f} & ( 3 )\end{matrix}$$

where e represents an entry from a set S comprising all permissible bit error patterns. It has been proven that at sufficiently high SNRs, the detection performance of an MLSD is determined by the lowest pre-detection SNR corresponding to a specific bit error pattern in terms of the definition in (3). It can be seen that the PSD of noise is shaped by the channel spectrum whereas it is not the case with threshold detection. When single bit errors prevail, i.e., |E(f)|=1, and wₖ takes the form of a noise-whitening filter with

$$W ( f ) = \frac{1}{\sqrt{N ( f )}} ,$$

(3) becomes the same as (1) (up to a constant), meaning ρ_{MFB} is obtained. For detailed reasoning, one can refer to Chapter 3 in [1].

In reality, ρ_{MFB} is not easily attainable because of a number of reasons. The noise can be not ideally whitened as it differs from drive to drive, from disc to disc, and even from run to run due to different working conditions; in a Viterbi detector, usually a finite impulse response (FIR) filter is used as an approximation of the actual channel response (h * w)ₖ (or hₖ with wₖ=1) to generate reference model outputs. The number of taps of the FIR filter directly determines the computational complexity of the detection, and in reality a 5-tap or 7-tap model is kind of affordable. Hence, a modelling error due to residual ISI would appear in the channel as an extra noise component. In addition, multiple bit errors can sometimes prevail because of, for instance, high capacity channels.

There are known some adaptive methods that try to realize noise-whitening without using the knowledge of the channel and noise. From “Eleftheriou, W. Hirt, Noise-Predictive Maximum-Likelihood Detection for Magnetic Recording Channel, IEEE Conf. Records ICC'96, pp. 556-560, June 1996” and “H. Yamagishi, M. Noda, Evaluation of RLL codes using simulation and experimental data, Philips-Sony QTB meeting, Tokyo, September 2005” two of these approaches are for example known. The former estimates the noise sequence and corrects it sample-based towards an uncorrelating sequence. The latter acquires the noise estimate as well and then filters the signal (both data and noise) to get the noise white. Both methods are bit-decision-directed, and thus need to be executed in bit-synchronous domain. The first example is extremely sensitive to bit errors, which makes it disadvantageous from a practical use point of view. Although the second example is somewhat more robust against bit errors thanks to its intrinsic low bandwidth parameter update, it changes the channel characteristics and usually results in an unacceptably wide channel span.

In FIG. 2, the spectra of the signal and noises in 25 GB BD at 1× rotating speed are plotted. The data curve represents the data spectrum |R(f)|², approximately equal to |H(f)|² without taking into account the d=1 constraint on the recorded bit sequence. The noise curve is the PSD of the noise N(f) that results mainly from the media noise (mainly at low frequencies) and electronic noise (at high frequencies). At 25 GB, with channel bit length T_{CBL}=74.5 nm and in units of baud rate f_{bank}=1/T_{CBL}, the optical cutoff fₒₚₜ equals 0.313 and the critical frequency f_{I2} equals 0.25 (indicated with a vertical arrow in the figure).

The relation between the data and noise spectra changes when the drive operates at higher speeds. As an example, the spectra at an 8× disc rotating speed are plotted in FIG. 3. A faster rotating speed allows more electronic noise entering the signal band, of which the amplitude is proportional to the rotating speed, and therefore the total noise level (basically the media noise remains unchanged), in particular at high frequency band, goes up dramatically. At 8×, the electronic noise level increases by about 27 dB with respect to that at 1×. For this reason, the center of the gravity of the noise spectrum shifts to the high frequency band. One can imagine that the shifting will become more obvious with even higher operation speeds.

As mentioned at the beginning, the number of taps of an FIR channel model required in Viterbi detection is limited by the affordable computational complexity. Normally a 5-tap FIR filter is adopted, which means a modelling error always exists as an additional noise source. The noise and model error curves in FIG. 2 and FIG. 3 indicate the noise spectra when the Viterbi detector uses a 5-tap model. One can see that some lobes are added on top of the original noise spectra, which change the signal and noise relationship significantly.

Two observations can be made from these curves. First, the whiteness of the noise, being required for achieving ρ_{MFB}, differs a lot at different speeds as well as with different numbers of taps given to the channel model. Secondly, the higher speeds one pursues, the more the gravity center of the noise shifts to the high frequency band. At 8×, the high frequency noise level goes up so much that it has exceeded the I2 data signal level. This makes it against intuition that a Viterbi detector still considers the whole frequency band information while a maximum pre-detection SNR is targeted.

It is an object of the invention to further develop the optical drives and methods of the type mentioned at the beginning such that the pre-detection SNR in terms of the form in equation (3) above are improved in order to get as close as possible to the ultimate target, i.e., μ_{MFB}.

### SUMMARY OF THE INVENTION

This object is solved by the features of the independent claims. Preferred embodiments and further developments are outlined in the dependant claims.

In accordance with a first aspect of the invention there is provided an optical disc drive comprising preprocessor means for preprocessing a disc readout signal rₖ and detector means for making bit decisions on the basis of a preprocessed disc readout signal yₖ, characterized in that the preprocessor means comprise low-pass filter means wₖ having a Fourier transform W(f) and a cutoff frequency f_{C} within the optical bandwidth. Without ideal and thus complicated noise whitening, the low-pass filters used in accordance with the invention aim at an optimal pre-detection SNR by squeezing out as much as possible noises (including modelling errors) whereas the loss of data information during the process can still be retrieved by, for example, Viterbi detection, and in the meantime getting the noise spectrum as flat as possible as well. The low-pass filters are preferably able to work at bit-asynchronous domain thus beneficial for timing recovery and with no aid of bit decisions thus having no error propagation problem. Preferred cutoff frequencies are, for example, in the range of 0.2˜0.3 f_{baud} with T_{CBL}=74.5 nm (25 GB) at speeds above 4×.

At least for some embodiments it is preferred that the low-pass filter means wₖ comprise at least one of the following filter types: IIR type low-pass filter, FIR type low-pass filter, equiripple type low-pass filter wₖ^{(I)}. For example, equiripple low-pass filters can be designed such that only the frequency components beyond the cutoff frequency get suppressed and the deformation on the pass band is kept as little as possible. Using such an equiripple low-pass filter for preprocessing the disc read out signal leads to virtual new optical channel with a hard cutoff. While at least is some cases better results are obtained with FIR type low-pass filters, IIR type low-pass filters have a smaller complexity and can also be used, particularly if complexity is an important factor.

It is also possible that the low-pass filter means wₖ comprise at least one noise-whitening type low-pass filter type wₖ^{(II)} having a Fourier transform approximated to

$$\frac{1}{\sqrt{N ( f )}} ,$$

wherein N(f) represents the power spectral density of additive noise nₖ. An approximation is necessary since the noise PSD N(f) is usually not exactly known. However, a good approximation can be made based upon the prior knowledge of the channel and noise. Thereby, a set of low-pass filters can be designed comprising a mild roll-off (compared to equiripple low-pass filters) and thus less taps in time domain.

At least for some embodiments of the disc drive in accordance with the invention it is preferred that the low-pass filter means wₖ comprise at least one low-pass filter of the type wₖ^{(III)}=(w^{(I)} * w^{(II)}ₖ, wherein * represents a linear convolution operation. This is due to the fact that because of the presence of triples the attenuation outside the optical band of the wₖ^{(II)} type low-pass filters is generally not as strong as that of the wₖ^{(I)} type low-pass filters. This can lead to a performance loss when Viterbi detection is sensitive to the out-of-band noises, for instance, in the presence of a modelling error. Hence, with low-pass filters of the type wₖ^{(III)}=(w^{(I)} * w^{(II)})ₖ an improvement can be reached, wherein the cutoff frequency of wₖ^{(I)} can be equal to fₒₚₜ in the simplest case.

In general it is preferred that the detector means comprise a like maximum likelihood sequence detector or a Viterbi detector. These detectors are well known to the person skilled in the art and are therefore not further explained here.

In accordance with a second aspect of the invention there is provided a method for preprocessing a disc readout signal rₖ of an optical drive, wherein the preprocessing comprises low-pass filtering the disc read out signal rₖ with low-pass filter means wₖ having a Fourier transform W(f) and a cutoff frequency f_{C} within the optical bandwidth. Thereby, the characteristics and advantageous discussed above in connection with the optical drive are also realized in line with a method.

The proposed filters are all of low pass feature. They reshape both the data channel and noise channel before detection for an improved pre-detection SNR. Depending on the trade-off between the suppression on noises and modelling errors, particularly the three types of filters discussed above and in further detail with reference to the drawings below can be used.

These and other aspects of the invention will be apparent from and elucidated with reference to the embodiments described hereinafter.

### BRIEF DESCRIPTION OF THE DRAWINGS

FIG. 1 shows a discrete time domain model of an optical disc readout process;

FIG. 2 shows BD signal and noise spectra at 1× speed;

FIG. 3 shows BD signal and noise spectra at 8× speed;

FIG. 4 shows a schematic block diagram of an optical drive in accordance with the invention, suitable to carry out the method in accordance with the invention;

FIG. 5 shows spectra of 3 FIR low-pass filters of Type I with stop band attenuation of 50 dB, 30 dB and 13.5 dB, respectively;

FIG. 6 shows Δρ_{MLSD} versus f_{C} at different speeds. ρ_{MLSD} with f_{C}=0.5 equals 15.1 dB, 17 dB, 14.3 dB and 12.1 dB for 1×, 8×, 10× and 12×, respectively;

FIG. 7 shows Δρ_{MLSD} versus f_{C} at different speeds. μ_{MLSD} with f_{C}=0.5 equals 14.2 dB, 15.4 dB, 13.45 dB and 11.56 dB for 1×, 8×, 10× and 12×, respectively. A 5-tap channel model is used for Viterbi detection;

FIG. 8 shows spectra of Type II shaping filters w^{II};

FIG. 9 shows ρ_{MLSD} as a function of the Viterbi channel model span for

Type I and Type II shaping filters;

FIG. 10 shows spectra of 3 FIR Type III shaping filters. A 201-tap wₖ^{(I)} with f_{C}=0.3 and stop band attenuation of 50 dB is taken for the convolution; and

FIG. 11 shows channel bit error rates of a Viterbi detector with different shaping filters at 8× speed 25 GB BD.

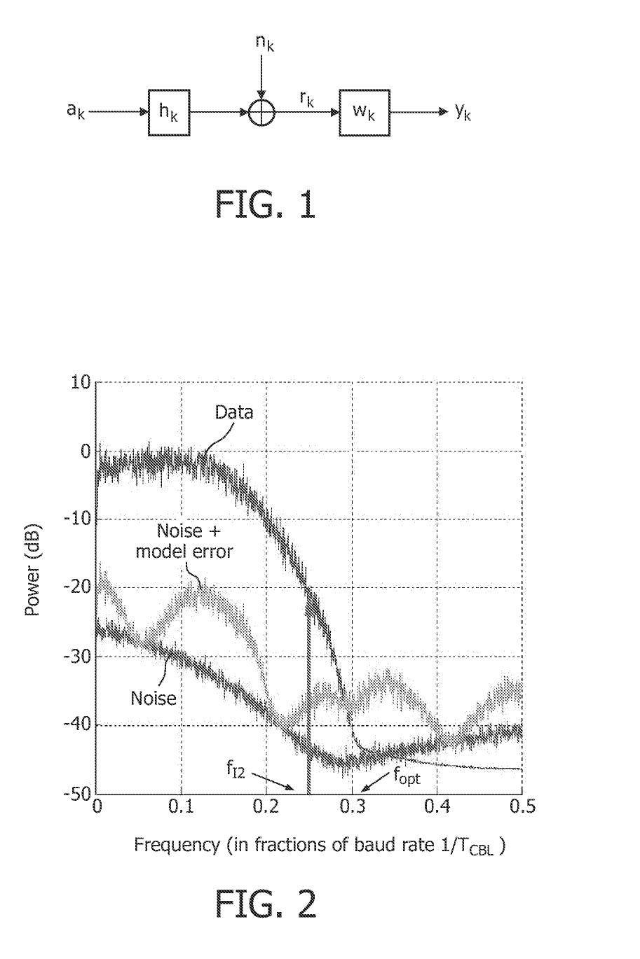

### DESCRIPTION OF PREFERRED EMBODIMENTS

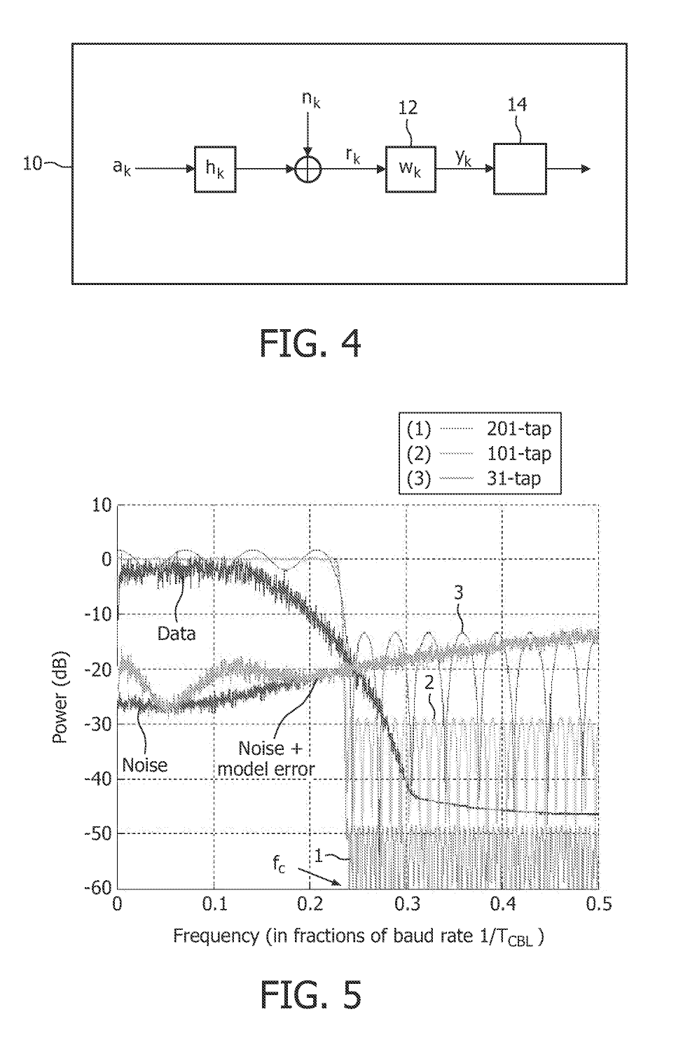

FIG. 4 shows a schematic block diagram of an optical drive in accordance with the invention, suitable to carry out the method in accordance with the invention. An optical disc drive 10 realizes the discrete time domain model of an optical disc readout process already discussed with reference to FIG. 1, wherein aₖ, nₖ and rₖ represent a binary input, additive noise and readout signal, respectively. hₖ represents a symbol response of the optical channel, the preprocessing means 12 comprise wₖ as a low-pass filter having a cutoff frequency f_{C} within the optical bandwidth, and yₖ its output going to the detector 14 which is preferably a Viterbi detector. The low-pass filter wₖ can be realized as a low-pass filter wₖ^{(I)}, wₖ^{(II)} or wₖ^{(III)} as discussed below.

Type I Shaping Filters wₖ^{(I)}

In FIG. 5, the spectra of three FIR filters are plotted that are of equiripple type and have rather sharp roll-off. To show the relation of the filter pass band and stop band with respect to the optical channel, the 8× BD signal and noise spectra are plotted there as well. The roll-off speed and attenuation factor at the stop band can be designed differently according to the requirements. In general, a steeper roll-off and a heavier stop band attenuation requires more taps. One can also consider infinite impulse response (IIR) type of filters for complexity reduction (lower order). The phase frequency responses of the filters should be of linear type so as not to cause any non-linear distortion on the channel phase characteristics.

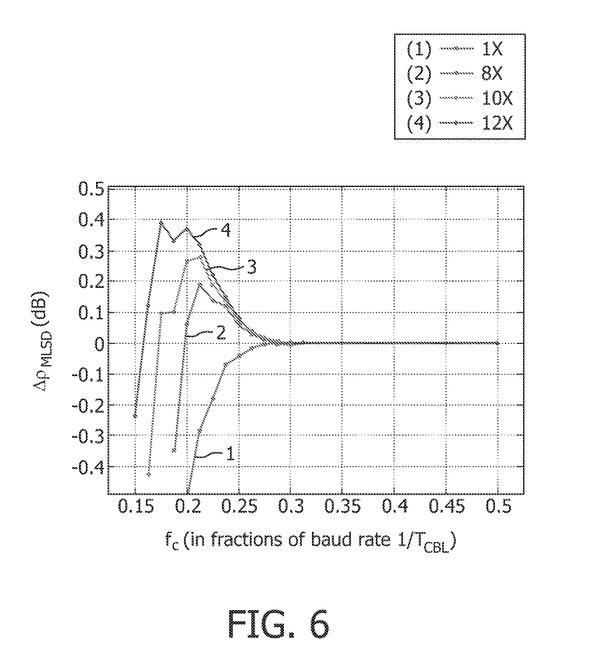

The type I shaping filter wₖ^{(I)} are designed in such a way that only the frequency components beyond the cutoff f_{C} get suppressed and the deformation on the pass band is kept as little as possible. It looks like a new optical channel with a “hard” cutoff \tilde{f}ₒₚₜ=f_{C} being artificially generated. Herein a filter designed with this criterion is called a Type I shaping filter wₖ^{(I)}. The cutoff frequency f_{C} should be chosen such that the pre-detection SNR, i.e., ρ_{MLSD}, is optimized. In FIG. 6, a relative ρ_{MLSD} value, Δρ_{MLSD}, as a function of f_{C} is plotted at different disc rotating speeds. Δρ_{MLSD} is defined as the deviation of ρ_{MLSD} relative to the value with f_{C}=0.5 (that is, no shaping filter applied). In the ρ_{MLSD} calculation, a 31-tap FIR model is assumingly used in the Viterbi detector, which means the modelling error is negligible. The 201-tap filter has been chosen for the simulation. At 1×, 20 dB media noise is added to have a certain bit error rate, while at other speeds no media noise is present. At 1×, a 5-tap fixed equalizer of [−5, 0, 32, 0, −5]/32] is used that whitens the noise to some extent.

When f_{C}≧fₒₚₜ, nothing happens because a Viterbi detector is basically insensitive to the noise beyond the channel given no modelling error. As f_{C}<fₒₚₜ, at high speeds ρ_{MLSD} first gets higher and then drops drastically when f_{C} becomes too low, while at low speeds ρ_{MLSD} consistently decreases with f_{C}. This can be explained as follows. No matter at low speeds where media noise is dominant or high speeds where electronic noise becomes more a problem, wₖ^{(I)} with f_{C}<fₒₚₜ in general always reshapes the noise spectrum towards being flatter, that is, more white, which is beneficial for Viterbi detection and will lead to a ρ_{MLSD} increase. On the other hand, when f_{C}<fₒₚₜ, part of the data information is thrown away. By its feature, a Viterbi detector is still able to retrieve the data when only I2 information is lost but in general breaks down if I3-related information gets lost as well. Nevertheless, ρ_{MLSD} tends to decrease due to the loss of data. As long as the increase due to noise whitening prevails, the detection performance improves in terms of ρ_{MLSD}. This is exactly what happens in high speed situations. The optimal f_{C} position shifts more towards low frequency as speed goes higher because at a higher speed ρ_{MLSD} gains more from noise flattening with relatively more noise components being cut away. This also leads to a bigger ρ_{MLSD} gain at a higher speed.

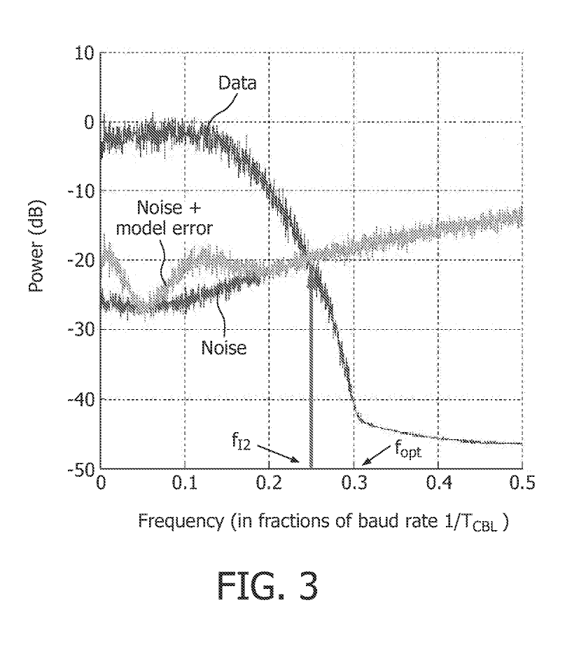

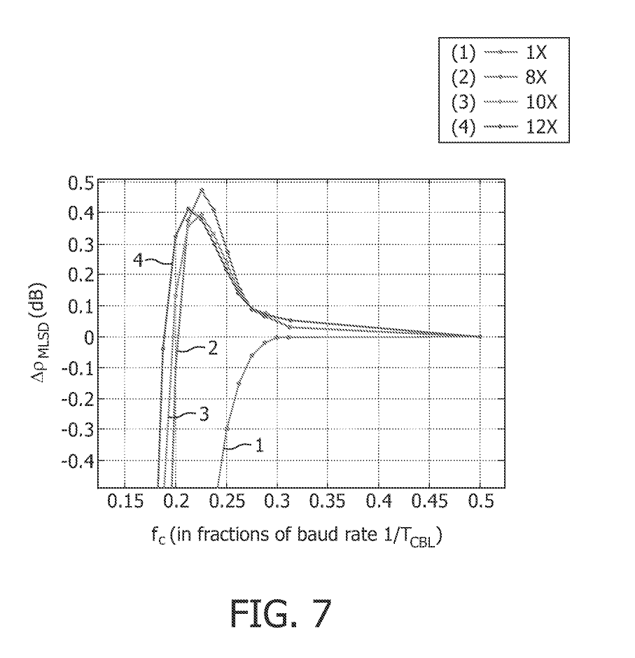

In FIG. 7, the Δρ_{MLSD} values given in FIG. 6 are recalculated and plotted with the number of channel model taps limited to 5 taps. Here a modelling error needs to be considered as an extra noise source. Due to that, ρ_{MLSD} drops about 1.5˜2 dB. However, the existence of the modelling error somewhat whitens the noise spectrum (see FIG. 3) and thus weakens the noise flattening effect of wₖ^{(I)}, leading to that at higher speeds an optimal ρ_{MLSD} occurs at a higher f_{C} and at low speeds ρ_{MLSD} drops faster as f_{C} decreases compared to the situations in FIG. 6. Here the ρ_{MLSD} gains are generally bigger as both noises and modelling errors, thus more noise components, are cut away. Interesting to see that ρ_{MLSD} already starts to increase when f_{C}<0.5 because a Viterbi detector gets sensitive to out-of-band noises when a modelling error exists.

As a conclusion, a simple wₖ^{(I)} filter with a cutoff frequency f_{C}<fₒₚₜ, or even stronger with f_{C}<f_{I2} (but still f_{C}<f_{I3}), will improve Viterbi performance at high speeds where high frequency noises are dominant.

Conventionally the disc rotating speed is defined in terms of the user data rate, for example, 1× BD is 36 Mb/s, that is, 4.95 m/s of a laser scanning speed. In a CLV (constant linear velocity) mode, the speed remains the same over one disc; while in a CAV (constant angular velocity) or zone-CAV mode, it increases from inner radii to outer radii (by a factor of>2), which means the disc rotating speed in terms of the user data rate varies. From FIG. 5 and FIG. 6, one sees that in general the optimal f_{C} is a function of speeds and ρ_{MLSD} drops rapidly when f_{C} drifts away from the optimum, especially when f_{C} gets too small, which can be interpreted as a filter used at speeds higher than the targeted speed.

In this case, one can either design a filter that satisfies the highest design speed or a filter bank in which each filter is designed for one speed and switched during the drive operation according to the radius. The former has a certain performance loss at lower speeds.

Type II Shaping Filters wₖ^{(II)}

From a noise-flattening point of view, at high speeds, a noise-whitening filter wₖ with

$$W ( f ) = \frac{1}{\sqrt{N ( f )}}$$

will give the best ρ_{MLSD} value if (h * w)ₖ is used as a channel model in Viterbi detection. This wₖ has a much milder roll-off so that it can be approximated by an FIR filter of a lower order than Type I shaping filters. Normally an ideal wₖ is not obtainable because an exact noise PSD N(f) is unknown. However, a good approximation can be made based upon the prior knowledge of the channel and noise, and it gives a set of low-pass filters with mild roll-off and thus less taps in time domain. Herein they are called Type II shaping filters wₖ^{(II)}.

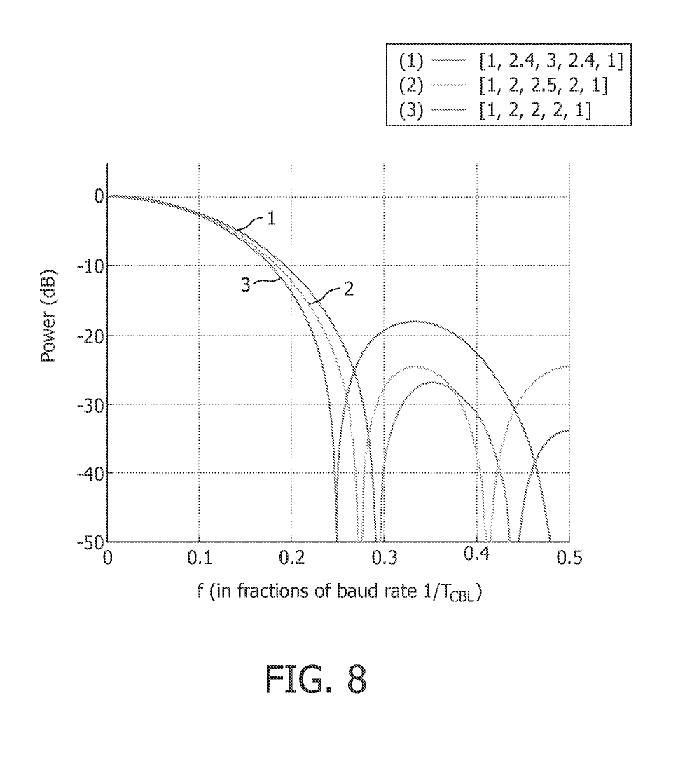

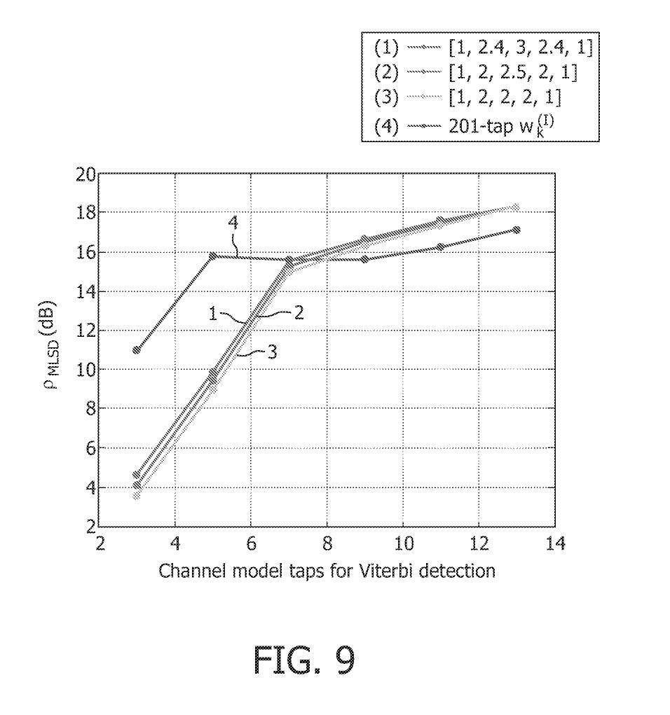

In FIG. 8 three examples are shown for 8× BD, namely [1, 2.4, 3, 2.4, 1], [1, 2, 2.5, 2, 1] and [1, 2, 2, 2, 1]. They are 5-tap FIR filters and have the first spectral notch at different frequencies. With different spectral notch positions, the high frequency contents of the noise are attenuated to a different degree. Unlike Type I shaping filters that have almost a flat spectrum in the pass band, a Type II shaping filter in principle starts attenuation right from DC. It gives more low-pass effects so that the span of the resulting channel (h * w)ₖ increases more significantly. In FIG. 9, the ρ_{MLSD} values are plotted as a function of the number of channel model taps used for Viterbi detection. Compared to a 201-tap wₖ^{(I)}, all three wₖ^{(II)} filters provide higher ρ_{MLSD} values when the model accommodates the real channel span. That is because in general a wₖ^{(II)} filter does better noise-whitening. When the tap number of the model goes to a practical region, i.e., around 5, due to a large modelling error ρ_{MLSD} drops dramatically for the wₖ^{(II)} filters while keeping a close-to-optimum level for a wₖ^{(I)} filter.

Therefore, a Type II shaping filter is preferably used if an increased hardware complexity in detection becomes affordable where the tap number of the channel model can go above 7.

Type III Shaping Filters wₖ^{(III)}

It is seen in FIG. 8 that due to the presence of ripples the attenuation outside the optical band of a Type II shaping filter is generally not as strong as that of a Type I shaping filter. This can lead to a performance loss when Viterbi detection is sensitive to the out-of-band noises, for instance, in the presence of a modelling error. Hence, improvement is reached if a filter takes the form of

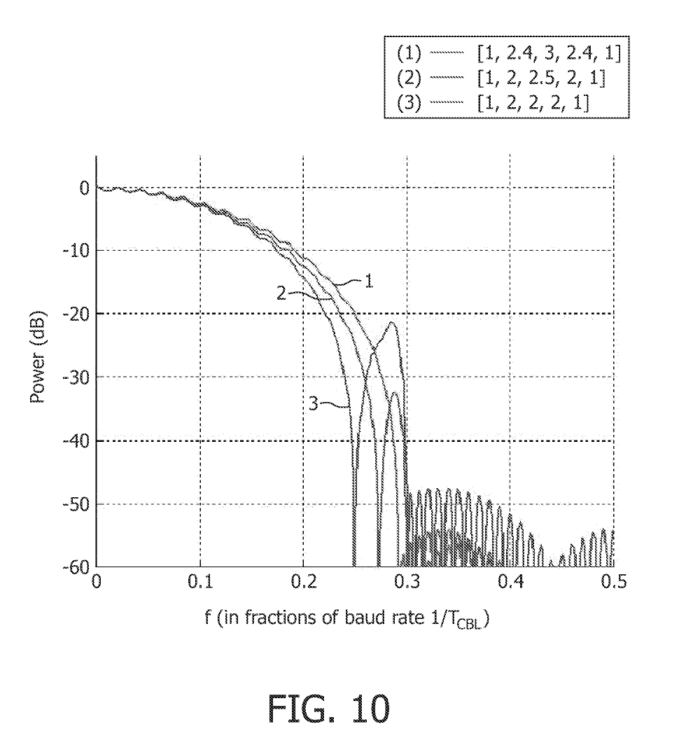

wₖ^{(III)}=(w^{(I)}*w^{(II)})ₖ (4)

where the cutoff frequency of wₖ^{(I)} can be equal to fₒₚₜ in the simplest case. wₖ^{(III)} is here called a Type III shaping filter. The spectra of some filter examples for 8× BD are shown in FIG. 10. It is seen that a Type III filter takes the spectrum shape of a Type II filter at the pass band of a Type I filter and has strong attenuation elsewhere. The required filter taps will be in between those of two other types of filters. And the channel span change will be similar to that of a Type II filter.

### Simulation Example

Data part of the signal is generated with a Braat-Hopkins model, on which media noise and electronic noise are added. Media noise level is 20 dB. Electronic noise level corresponds to that at 8× rotation speed (with 39 dB at 1×, see “ T. P. H. G. Jansen, A. Stek, Signal to Noise calculation model for Blu-ray Disc system, Philips Research Technical Note 2002/360, 2002”). A Viterbi detector using a 5-tap model is executed on two sets of signals. The first set is called “Original”, including four signal sequences with and without shaping filters. In the second set, “ISI compensated”, the four signal sequences are preprocessed with a so-called ISI cancellation technique in order to eliminate the impact of channel span increase of the low-pass filtering on the detection performance. “Type I” is referred to a 101-tap wₖ^{(I)} with an optimized f_{C}; “Type II” a 5-tap FIR filter [1, 2.4, 3, 2.4, 1] given in FIG. 7; and “Type III” a linear convolution of the two.

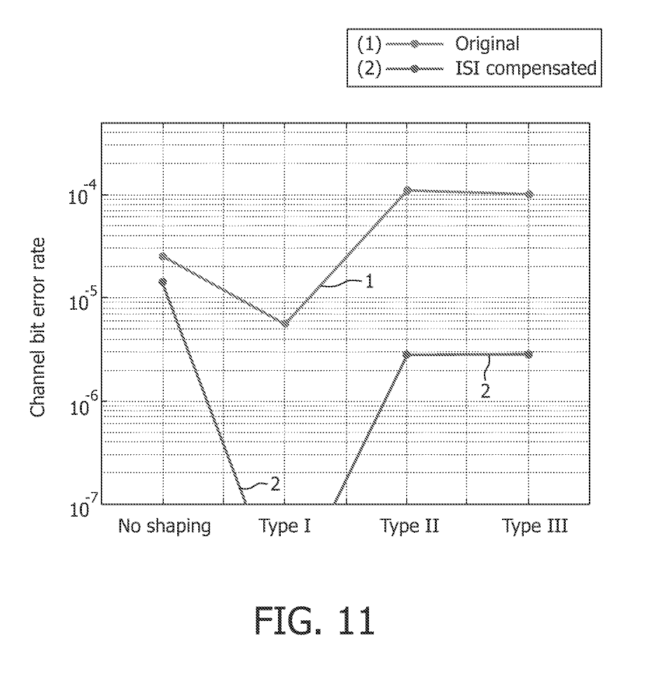

The resulting channel bit error rates (CBER) are recorded in FIG. 11. One can see that the Type I shaping lowers CBER for both data sets due to noise whiteness improvement with mild channel span increase, while the CBER reduction for the other two shaping filters becomes visible only when the ISI cancellation technique is applied. It implies that in this case the channel span increase ruins the noise whiteness improvement. This can be solved by this ISI cancellation technique or using more taps for the channel model in Viterbi detection. The latter, however, requires more hardware cost.

With the channel expansion effect being compensated, one can imagine that with the further increase of the electronic noise level, the CBERs with Type II and III shaping filters will get lower than that with a Type I filter because in principle they do a better job in noise-whitening.

The present invention discloses an optical drive and a method for preprocessing a disc readout signal rₖ of an optical drive on the basis of a set of low-pass filters. The cutoff frequency f_{C} of the filters wₖ, more particularly, can be set within the optical bandwidth, which improves the Viterbi detection performance in the case of high speed drive operations. Three types of filters are described, in which a Type I shaping filter performs best given a limited hardware cost for the bit detector. Compared to other more advanced noise-whitening techniques, it is only speed dependent and requires little prior knowledge of the channel and noise, thus cheap and easy to design. The invention can be applied in connection with optical disc drives, in particular when high frequency noises are dominant, for example, in the case of high speed operations.

Finally, it is to be noted that equivalents and modifications not described above may also be employed without departing from the scope of the invention, which is defined in the accompanying claims.

1. An optical disc drive (10) comprising preprocessor means (12) for preprocessing a disc readout signal rₖ and detector means (14) for making bit decisions on the basis of a preprocessed disc readout signal yₖ, characterized in that the preprocessor means (12) comprise low-pass filter means wₖ having a Fourier transform W(f) and a cutoff frequency f_{C} within the optical bandwidth.

2. The disc drive (10) according to claim 1, wherein the low-pass filter means wₖ comprise at least one of the following filter types: IIR type low-pass filter, FIR type low-pass filter, equiripple type low-pass filter wₖ^{(I)}.

3. The disc drive (10) according to claim 1, wherein the low-pass filter means wₖ comprise at least one noise-whitening type low-pass filter type wₖ^{(II)} having a Fourier transform approximated to
$$\frac{1}{\sqrt{N ( f )}} ,$$
wherein N(f) represents the power spectral density of additive noise nₖ.

4. The disc drive (10) according to claim 1, wherein the low-pass filter means wₖ comprise at least one low-pass filter of the type wₖ^{(III)}=(w^{(I)} * w^{(II)})ₖ, wherein * represents a linear convolution operation.

5. The disc drive (10) according to claim 1, wherein the detector means (14) comprise a like maximum likelihood sequence detector or a Viterbi detector.

6. A method for preprocessing a disc readout signal rₖ of an optical drive (10), characterized in that the preprocessing comprises low-pass filtering the disc read out signal rₖ with low-pass filter means wₖ having a Fourier transform W(f) and a cutoff frequency f_{C} within the optical bandwidth.
